(19) United States
(12) Patent Application Publication
(10) Pub. No.: US 2016/0052461 A1
(43) Pub. Date: Feb. 25, 2016

(54) STOR-ALL VEHICLE STORAGE COMPARTMENT

(71) Applicant: Gregory Hendricks, New Orleans, LA (US)

(72) Inventor: Gregory Hendricks, New Orleans, LA (US)

(21) Appl. No.: 14/827,143

(22) Filed: Aug. 14, 2015

Related U.S. Application Data
(60) Provisional application No. 62/037,526, filed on Aug. 14, 2014.

(51) Int. Cl. B60R 9/06

(52) U.S. Cl. CPC B60R 9/06; B60R 9/065

(57) ABSTRACT

A plastic, wooden or aluminum storage box that is mounted to the rear interior wall of a pickup truck or in a trunk of a vehicle and functions as a single compact storage container for vehicle specific accessories.

### CLAIM OF PRIORITY

This patent application claims priority under 35 USC 119 (e) (1) from U.S. Provisional Patent Application Ser. No. 62/037,526 filed Aug. 14, 2014, of common inventorship herewith entitled, “STOR-ALL Vehicle Storage Compartment,” which is incorporated herein by reference as though the same were set forth in its entirety.

### FIELD OF THE INVENTION

The present invention pertains to the field of storage products, and more specifically to the field of lidded storage containers for vehicles.

### BACKGROUND OF THE INVENTION

The prior art has put forth several designs for lidded storage containers for vehicles. Among these are:

U.S. Pat. No. 6,644,523 to James R. Salas describes a storage device for positioning below a rear seat in a pickup truck. The storage device includes a housing having a bottom wall and a peripheral wall attached to and extending upwardly from the bottom wall. The peripheral wall includes a front wall, a back wall, a first side wall and a second side wall. A pair of intermediate walls extend from the back wall to the front wall and are spaced from each other such that the housing is divided into a first compartment, a second compartment and a third compartment wherein the second compartment is positioned between the first and third compartments. A cover is pivotally coupled to an upper edge of the back wall. The cover is positionable over the housing. The housing is positioned below a rear seat in a pickup truck.

U.S. Pat. No. 5,667,115 to Martien Verhaeg describes an interior vehicle storage container including one or more storage compartments securable by one or more substantially flat covers. Three storage compartments are integrally formed within a single enclosure and separated and covered by three substantially flat hinged covers. A middle storage compartment has a height dimension less than the height dimension of a left end compartment and a right end compartment, for straddling a raised surface on the floor of the vehicle. The middle compartment and the right end compartment share a common wall through which an aperture protrudes for storing a long item, such as a car jack handle through both the middle and right end compartments. Alternatively, the three compartments are separately constructed and configured to integrally fit together. An exterior restraint apparatus is included for restraining goods stacked on top of the substantially flat covers such as grocery bags and the like.

U.S. Pat. No. 2,934,374 to Hans B. Mortenson and Nina E. Mortensen describes an auxiliary storage compartment for vehicles that provides a compartment or compartments for storing small objects which are accessible from the interior of the vehicle, occupying space normally wasted. The compartment occupies the space which normally exists between the back of the rear seat of a vehicle and the rear window thereof. The compartment extends only a comparatively slight distance into the luggage compartment of the vehicle and then only into space normally unoccupied at the top of the luggage compartment. Said compartment have with a spring lid which is normally retained in closed position at all times. Said compartment have a forwardly sloping bottom surface, so that its contents are more readily accessible in the interior of the vehicle. Another object of this invention is to provide a vehicle with one or more removable storage compartments in the space back of its rear seat.

None of these prior art references describe the present invention.

### SUMMARY OF THE INVENTION

It is an object of the present invention to provide a plastic, wooden or aluminum storage box that is mounted to the rear interior wall of a pickup truck or in a trunk of a vehicle and functions as a single compact storage container for vehicle specific accessories.

### BRIEF DESCRIPTION OF THE DRAWINGS

FIG. 1 is an illustrative prototypical top down of the present invention showing a hinged lid and a lock.

FIG. 2 is a prototypical functional diagonal view showing an aftermarket version of the present invention mounted to the rear interior wall in a pickup truck with its lid partially open.

FIG. 3 is a prototypical functional diagonal view showing a manufacturer's built in version of the present invention mounted to the rear interior of a pickup truck with its lid partially open.

FIG. 4 is an illustrative prototypical partial back view of the present invention with its lid partially open and showing two mounting holes located on its back side.

### DETAILED DESCRIPTION OF THE INVENTION

For many individuals, a car is a symbolic conduit of freedom and independence. At a young age, a person begins to dream of hitting an open road, driving to any destination and showing off a cool car. Cars transport people from one point to another point, but also portray each owner's personality and lifestyle. To young owners, a first car represents dates, joyrides, impromptu road trips and plenty of free time cruising with windows down and the music blasting. To young adults, a car provides transportation to and from work, ample space for carpooling children and a method for carting supplies and groceries. To older adults, cars are comparable to a smooth ride for travel to vacation destinations, running in town errands and dining out or attending a cultural-event any night of the week. Cars are an integral and proud possession of individuals in many societies. Individuals wash and wax their vehicles, clean and polish their vehicle's wheels, and purchase aftermarket options to enhance their driving experience.

The present invention, hereinafter referred to as STOR-ALL Vehicle Storage Compartment, or simply STOR-ALL, is a storage box that is mounted to the rear interior wall of a pickup truck or in the trunk of a vehicle and functions as a single compact storage container for vehicle specific accessories. Neither too big nor too small, STOR-ALL is sized to hold various items such as those items that keep one's car running and looking good and small items needed and used while one is driving around. STOR-ALL holds tools, cleaning products and any other items someone primarily keeps in their vehicle and doesn't want to lose track of over a course of a long work week and through their busy personal lives.

The hinged lid 14 slopes downward toward the front of the compartment. This means the rear wall of the compartment is higher than the front wall of the box.

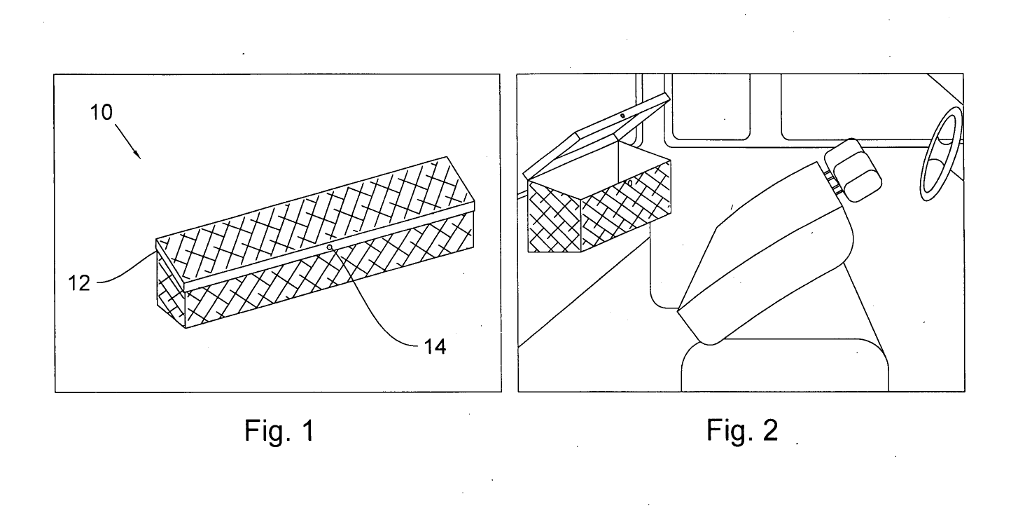

FIG. 1 is a perspective view showing the storage compartment 10 made from aluminum. The storage compartment 10 has a forward sloping lid 14 for easy access to contents of the compartment 10. A keyed lock 20 secures the lid 14 to the main storage area 22 to prevent unwanted access to the contents of the compartment.

FIG. 2 shows the compartment 10, mounted to a rear wall in the cab of a pickup truck with lid 14 raised, wherein the compartment is made from aluminum.

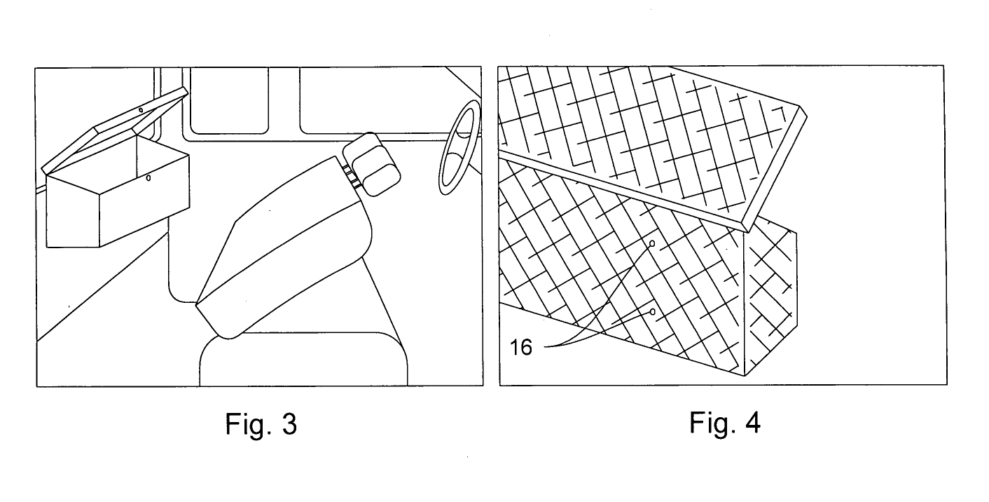

FIG. 3 shows the compartment 10, mounted to a rear wall in the cab of a pickup truck with lid 14 raised, wherein the compartment is made from wood.

FIG. 4 depicts the rear of the storage compartment showing one pair of mounting holes 24 for securing the compartment 10 to the rear wall of the cab. It is contemplated that two or more pairs of mounting holes spaced apart along the rear wall of the compartment 10 are used to secure the compartment 10 to the rear wall of the cab.

Manufactured in wood, plastic or aluminum material, STOR-ALL comes in various colors such as brown, black or silver. In an embodiment, the STOR-ALL measures approximately four feet two inches by eight inches by twelve inches. Configured to fit in both cars and trucks, STOR-ALL is easily placed in and removed from the back wall of the cab of one's pickup truck and will even fit in a vehicle's trunk if a car owner elects to place it there. Ice scrapers, tire gauges, surface cleaners, flashlights, pocket umbrellas, brushes, extra air fresheners and seldom used keys are all items that roll about car floors and trunks when uncontained. STOR-ALL provides a compact, securable and easily accessible container for storing all these accessories. No longer are these items rolling around a vehicle, they now are contained in a sleek STOR-ALL container, easy to locate when needed.

Although this invention has been described with respect to specific embodiments, it is not intended to be limited thereto and various modifications which will become apparent to the person of ordinary skill in the art are intended to fall within the spirit and scope of the invention as described herein taken in conjunction with the accompanying drawings and the appended claims.

1. A storage box mountable to the rear interior wall of a pickup truck cab or in a trunk of a vehicle, comprising:
a rectangular box having a front, a back and a hinged lid, wherein the hinged lid slopes downward toward the front of the box.

2. The storage box of claim 1 further comprising a keyed lock mounted on the lid to secure the lid to the box.

3. The storage box of claim 1 made from aluminum.

4. The storage box of claim 1 made from wood.

5. The storage box of claim 1 made from plastic.

6. The storage box of claim 1 made from a combination of aluminum, wood and plastic.

7. The storage box of claim 1 wherein the box is mounted by at least two pairs of mounting holes on the back of the box.

8. The storage box of claim 1, manufactured in brown, black, or silver color.

9. The storage box of claim 1, wherein the box measures approximately four feet two inches in length, eight inches in width and twelve inches in height at the back of the box.
